(19) United States
(12) Patent Application Publication
(10) Pub. No.: US 2022/0227436 A1
(43) Pub. Date: Jul. 21, 2022

(54) DEBRIS PATH FOR MINING TRACK UTILIZING A SEALED JOINT

(71) Applicant: Caterpillar Inc., Peoria, IL (US)

(72) Inventors: Benjamin Isaac Jones, Bartonville, IL (US); Mark J. Kiesel, Peoria, IL (US); Brian Konrad Loeffler, Germantown Hills, IL (US)

(73) Assignee: Caterpillar Inc., Peoria, IL (US)

(21) Appl. No.: 17/153,039

(22) Filed: Jan. 20, 2021

(51) Int. Cl. B62D 55/088; B62D 55/21

(52) U.S. Cl. CPC B62D 55/088; E02F 3/301; B62D 55/21

(57) ABSTRACT

A track chain assembly includes a first track pad including a first pair of lugs defining a gap therebetween, and a second track pad including an intermediate lug disposed in the gap. The first pair of lugs and the intermediate lug each define a concentric bore, defining an axis of rotation for a pinned joint of the track chain assembly, and the concentric bore of one of the first pair of lugs is in communication with the gap with a first blend disposed axially between the gap and the concentric bore.

### TECHNICAL FIELD

The present disclosure relates to track pads that are used to support heavy equipment such as hydraulic mining shovels, and the like. Specifically, the present disclosure relates to such track pads that allow debris or other contaminants to migrate away from seals used in a pinned joint that joins a pair of such track pads.

### BACKGROUND

In various mining applications, the track pad is subject to heavy loads, requiring that the track pad be robust. Also, dirt, rocks, debris, and other contaminants may infiltrate various components of a track chain using such track pads. More specifically, the track chain using such track pads may have a pinned joint with seals for preventing the unwanted loss of lubrication. Contaminants may infiltrate these seals, which can eventually damage the seal or otherwise interfere with the seal's function, allowing lubrication to leak out of the joint. Eventually, the lack of lubrication may cause galling, seizing, or other mechanical problems with the track chain, necessitating maintenance of the track chain and downtime for the machine. This is unwanted since it adversely affects the profitability of an economic endeavor using the machine.

Chinese patent no. CN2702902Y discloses a track driven machine including a track chain with two chain links that form a pinned joint. More particularly, a pin and a bushing with a seal are provided. The bushing has chamfers on its outer circumferential surface at the axial ends of the bushing. Similar chamfers are provided on the interior circumferential surface at the axial ends of the bushing. The inner chamfers extend further axially than the outer chamfers. The purpose of these chamfers is to ease assembly of the pinned joint, provide for a long service life, and reduce the amount of noise created by the pinned joint as the track chain moves.

However, this prior art fails to disclose a track pad or a track chain that helps reduce the likelihood of contaminants infiltrating a seal assembly of the pinned joints of the track chain, etc.

### SUMMARY

A track pad according to an embodiment of the present disclosure may comprise a shoe member including a ground engaging surface, and defining a track chain traveling direction, a lateral direction perpendicular to the track chain traveling direction, and a vertical direction perpendicular to both the lateral direction, and the track chain traveling direction. The shoe member may further define a first lateral end, a second lateral end, a front end along the track chain traveling direction, and a rear end along the track chain traveling direction, a lateral distance from the first lateral end to the second lateral end, and a width from the front end to the rear end along the track chain traveling direction that is less than the lateral distance. A first link member may extend upwardly from the shoe member including a first lug member extending from the first link member in a first direction parallel to the track chain traveling direction, as well as a second lug member and a third lug member both extending from the first link member in a second direction opposite of the first direction, forming a first fork portion including a first lateral outside surface, a second lateral outside surface, a first lateral outside surface, a second lateral outside surface, a first lateral inside surface, and a second lateral inside surface. The second lug member defines a first aperture that extends laterally through the first lateral outside surface and the first lateral inside surface, forming a first intersection with the first lateral inside surface that includes a first blend extending from the first lateral inside surface to the first aperture.

A track pad according to another embodiment of the present disclosure may comprise a shoe member including a ground engaging surface, and defining a track chain traveling direction, a lateral direction perpendicular to the track chain traveling direction, and a vertical direction perpendicular to both the lateral direction, and the track chain traveling direction. The shoe member may further define a first lateral end, a second lateral end, a front end along the track chain traveling direction, and a rear end along the track chain traveling direction, a lateral distance from the first lateral end to the second lateral end, and a length from the front end to the rear end along the track chain traveling direction that is less than the lateral distance. A first link member may extend upwardly from the shoe member including a first top rail surface (e.g., may be planar), a first lug member extending from the first link member in a first direction parallel to the track chain traveling direction, and a second lug member and a third lug member both extending from the first link member in a second direction opposite of the first direction. The second and the third lug members may define a first pair of chamfered surfaces that are laterally opposite of each other and facing each other.

A track chain assembly according to an embodiment of the present disclosure may comprise a first track pad including a first pair of lugs defining a gap therebetween, and a second track pad including an intermediate lug disposed in the gap. The first pair of lugs and the intermediate lug each may define a concentric bore, defining an axis of rotation for a pinned joint of the track chain assembly, and the concentric bore of one of the first pair of lugs is in communication with the gap with a first blend disposed axially between the gap and the concentric bore of one of the first pair of lugs.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 illustrates a machine in the form of a hydraulic mining shovel that has an undercarriage that may use track chain assemblies having track pads constructed according to the various embodiments disclosed herein.

FIG. 2 is a perspective view of a portion of the undercarriage, track chain assembly, and track pads of FIG. 1.

FIG. 3 is a sectional view of the track chain assembly including the two track pads of FIG. 2 taken along lines 3-3 thereof, depicting a pinned joint that allows the track chain assembly to be flexible since the track pads are free to rotate relative to each other along with a debris path allowing contaminants to egress away from the seal assembly of the pinned joint.

FIG. 4 is an enlarged detail view of a single instance of the debris path of FIG. 3, showing the debris path more clearly.

FIG. 5 is a side sectional view of a single instance of the track pad of FIG. 2, taken along lines 5-5 thereof.

FIG. 6 is an enlarged detail view of the track pad of FIG. 2, showing the chamfer(s) that may provide one boundary of the debris path of FIG. 4.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b etc. It is to be understood that the use of letters immediately after a reference number indicates that these features are similarly shaped and have similar function as is often the case when geometry is mirrored about a plane of symmetry. For ease of explanation in this specification, letters will often not be included herein but may be shown in the drawings to indicate duplications of features discussed within this written specification.

While the arrangement is illustrated in connection with a hydraulic mining shovel, the arrangement disclosed herein has universal applicability in various other types of machines commonly employ track systems, as opposed to wheels. The term “machine” may refer to any machine that performs some type of operation associated with an industry such as mining, earthmoving, or construction, or any other industry known in the art. For example, the machine may be an excavator, wheel loader, cable shovel, or dragline or the like. Moreover, one or more implements may be connected to the machine. Such implements may be utilized for a variety of tasks, including, for example, lifting and loading. Among other uses, a hydraulic mining shovel can be used to load overburden and ore into haul trucks during the mining process in various surface mine applications.

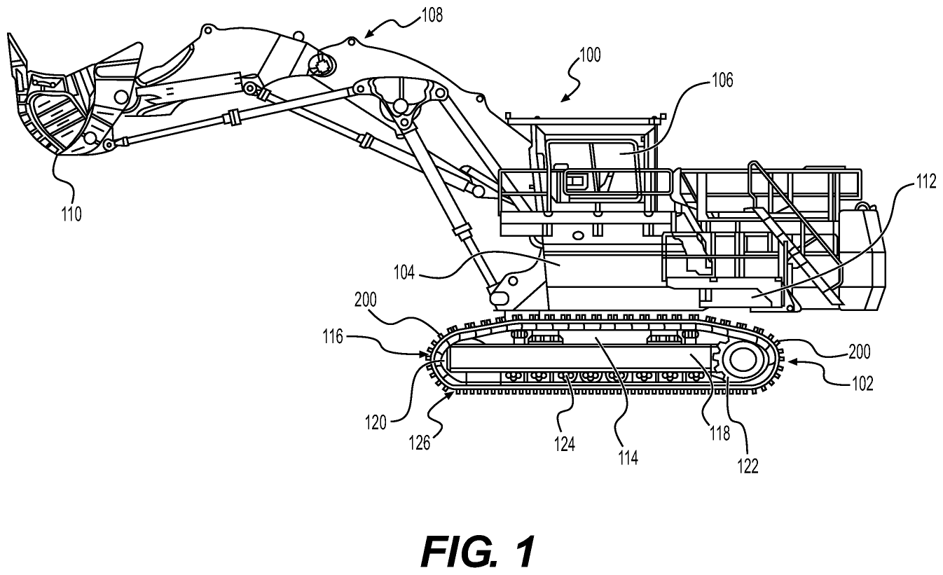

Looking at FIG. 1, a machine 100 that may use track pads constructed according to various embodiments of the present disclosure can be seen. The machine 100 may include a body 104 with a cab 106 to house a machine operator. The machine may also include a boom system 108 pivotally connected at one end to the body 104 and supporting an implement 110 at an opposing, distal end. In embodiments, the implement 110 can be any suitable implement, such as a bucket, a clamshell, a blade, or any other type of suitable device. A control system can be housed in the cab 106 that can be adapted to allow a machine operator to manipulate and articulate the implement 110 for digging, excavating, or any other suitable application.

The body 104 may be supported on a main frame 112 supported on an undercarriage structure 114. The undercarriage structure 114 includes a supporting structure 118 that supports a track system 102 utilized for movement of the machine 100. The track system 102 may include first and second track roller frame assemblies 116, which are spaced from and adjacent respective first and second sides of the undercarriage structure 114. It will be appreciated that only one of the track roller frame assemblies 116 is visible in FIG. 1.

Each of the track roller frame assemblies 116 carries an idler wheel 120, a drive sprocket wheel 122, and a plurality of track guiding rollers 124. The drive sprocket wheel 122 is powered in forward and reverse directions by the machine 100 (via a motor such as an internal combustion engine). An endless track chain assembly 126 encircles each drive sprocket wheel 122, the idler wheel 120, and the track guiding rollers 124. The track chain assembly 126 includes a plurality of interconnected track pads 200, also referred to as track chain members. The track guiding rollers 124 guide the track pads 200 as the track chain assembly 126 is driven by the drive sprocket wheel 122.

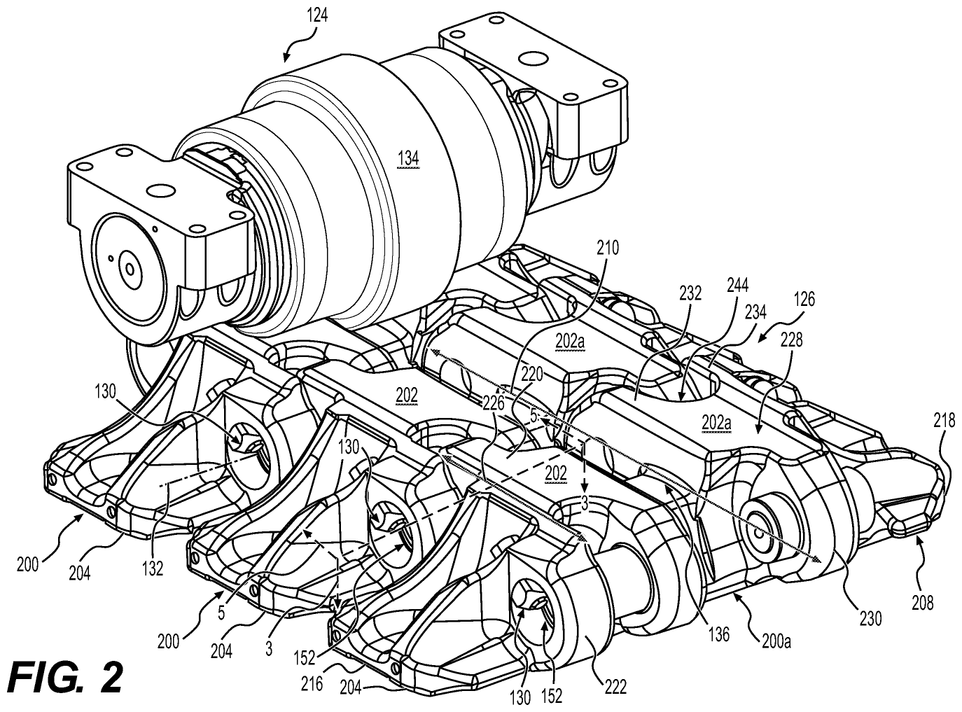

FIG. 2 illustrates a portion of the track chain assembly 126 including two pads 200 that are pivotally connected to each other. A track roller 124 is also shown that rides on the rail surfaces 202, 202a of the track pads 200. Hence, the weight of the machine 100 is transmitted through the undercarriage structure 114 (see FIG. 1) through the track rollers 124 to the track pad 200, which transmits that load to the ground through its ground engaging surface 204. A thru-slot 136 extends along the track chain traveling direction 210 that allows the guide ridge 134 of the track roller to pass from one track pad to the next unhindered while providing lateral guidance of the track chain assembly 126.

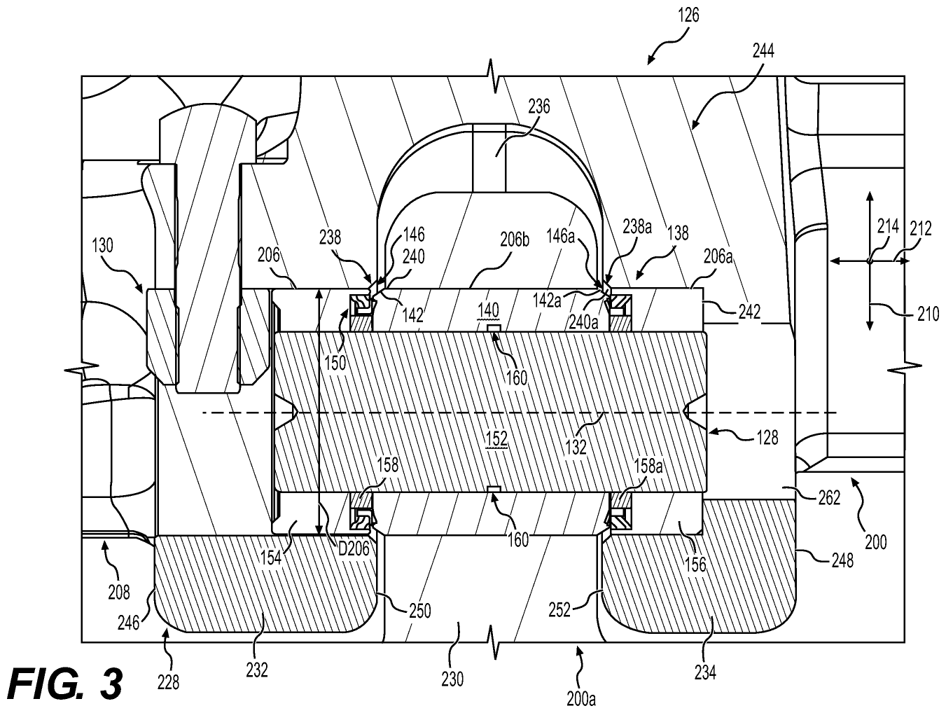

FIG. 3 depicts the pinned pivotal connection of a track pad 200 to an adjacent track pad 200, which may be similarly or identically configured as each other in order to form the track chain assembly 126. A pin 152 (e.g., may be part of a cartridge pin assembly 128) is shown that is disposed in the bores 206 of the lug members of the link members of the track pads 200 (which will be discussed in more detail momentarily), allowing one track pad 200 to pivot relative to the other. A pin retention bolt assembly 130 that helps to prevent “walking” of the cartridge pin assembly 128 laterally out of the bores is also shown.

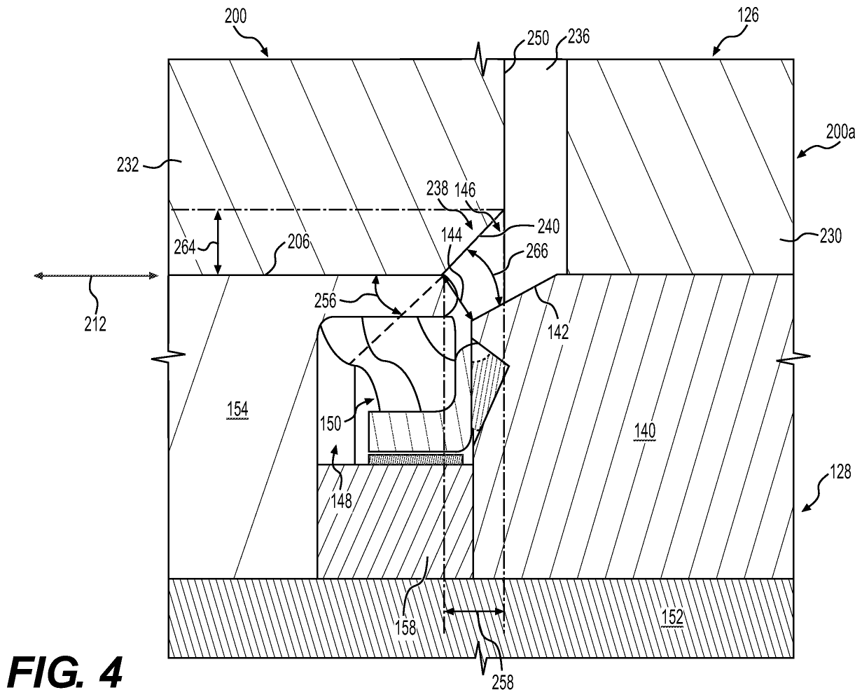

The track chain assembly 126 according to an embodiment of the present disclosure may be further characterized as follows with reference to FIGS. 3 and 4. The track chain assembly 126 may comprise a first track pad 200 including a first pair of lugs (later referred to herein as a second lug 232 and a third lug member 234) defining a gap 236 laterally between the second lug and the third lug. A second track pad 200a may also be provided that includes an intermediate lug (later referred to herein as a first lug 230) that is disposed in the gap 236. The first pair of lugs and the intermediate lug each defines a concentric bore (e.g., see 206, 206a, 206b), defining an axis of rotation 132 for a pinned joint 138 of the track chain assembly 126, and the concentric bore (e.g., 206) of one of the first pair of lugs is in communication with the gap 236 with a first blend 238 disposed axially between the gap 236 and the concentric bore 206 of one of the first pair of lugs.

As used herein, a “blend” means any transitional surface that connects two adjacent surfaces and may include an arcuate surface (e.g., a radius, an ellipse, a polynomial spline, etc.), or a chamfer (e.g., a conical face), etc.

Similarly, the concentric bore 206a of the other of the first pair of lugs may also be in communication with the gap 236 with a second blend 238a disposed axially between the gap 236, and the concentric bore 206a of the other of the first pair of lugs.

More specifically, the first blend 238 may take the form of a first interior chamfer 240 (so called since it faces laterally toward the gap 236), and the second blend 238a may take the form of a second interior chamfer 240a. This may not be the case for other embodiments of the present disclosure.

Each of the concentric bore 206, 206a, 206b may define the same diameter D206 (i.e., within 0.005 of an inch of each other), but not necessarily so. When true, and the track chain assembly 126 may further comprise a cartridge pin assembly 128 that is disposed in each concentric bore 206, 206a, 206b to help provide the pivoting function of the pinned joint 138.

To that end, the cartridge pin assembly 128 may include a bushing 140 defining a first bushing chamfer 142 at one of its lateral ends, and a second bushing chamfer 142a at the other of its lateral ends that are in communication with the gap 236. The first bushing chamfer 142 may be parallel to the first interior chamfer 240, and the second bushing chamfer 142a may be parallel to the second interior chamfer 240. In such a case, these chamfers by be symmetrical to each other about a midplane disposed laterally between them. This may not be the case for other embodiments of the present disclosure.

In other embodiments as shown in FIG. 4, a funnel angle 266 may be formed between the first bushing chamfer 142, and the first interior chamfer 240 that diverges toward the gap 236 to help force contaminants away from the seal assembly 150. A similar arrangement could be present for the second bushing chamfer 142a and the second interior chamfer 142a. This funnel angle 266 may equal to or greater than 10 degrees. As shown, this angle may range from 15.0 degrees to 25.0 degrees (e.g., 20.0 degrees).

More particularly, the first bushing chamfer 142 may be spaced away from the first interior chamfer 140 a minimum distance 144 (see FIG. 4), forming a first debris path 146. A second debris path 146a may be formed by the second interior chamfer 140a and the second bushing chamfer 142a (see FIG. 3). These paths may allow dirt, debris, or other contaminants to egress away from the seals of the pinned joint.

Focusing on FIG. 4, the cartridge pin assembly 128 may define a seal receiving void 148 that is in communication with one of the concentric bores (e.g., see 206), and the first debris path 146. A seal assembly 150 may be disposed therein.

Looking at FIGS. 3 and 4, a ratio of the same diameter D206 of each concentric bore to the minimum distance 144 may range from 15.0 to 30.0 in some embodiments of the present disclosure (e.g., 18.0 to 22.0). In such a case, the minimum distance 144 may range from 3.0 mm to 7.0 mm (e.g., 5.0 mm). Other ratios and dimensions are possible in other embodiments of the present disclosure.

As best seen in FIG. 3, one of the first pair of lugs (e.g., see 234) may include a shoulder stop surface 242, and the cartridge pin assembly 128 may be disposed axially adjacent to the shoulder stop surface 242 (e.g., may abut this surface).

Other components of the cartridge pin assembly 128 include a pin 152 or shaft, a first end collar 154 attached to the pin, a second end collar 156 attached to the pin, a first bearing 158 disposed radially and axially between the bushing 140, the pin 152 and the first end collar 154, and a second bearing 158a disposed radially and axially between the bushing 140, the pin 152, and the second end collar 156.

The bearings may help prevent the seal assembly 150 from being crushed by axial loads (so they may also be referred to as thrust bearings) while the bushing provides lubrication voids 160 to ease the rotation of the bushing, and therefore one track pad 200 relative to the pin and the end collars, and the other track pad 200a.

Details of various embodiments of the track pad that may be used to construct and/or repair, etc. the track chain assembly will now be discussed in detail with reference to FIGS. 2 thru 6.

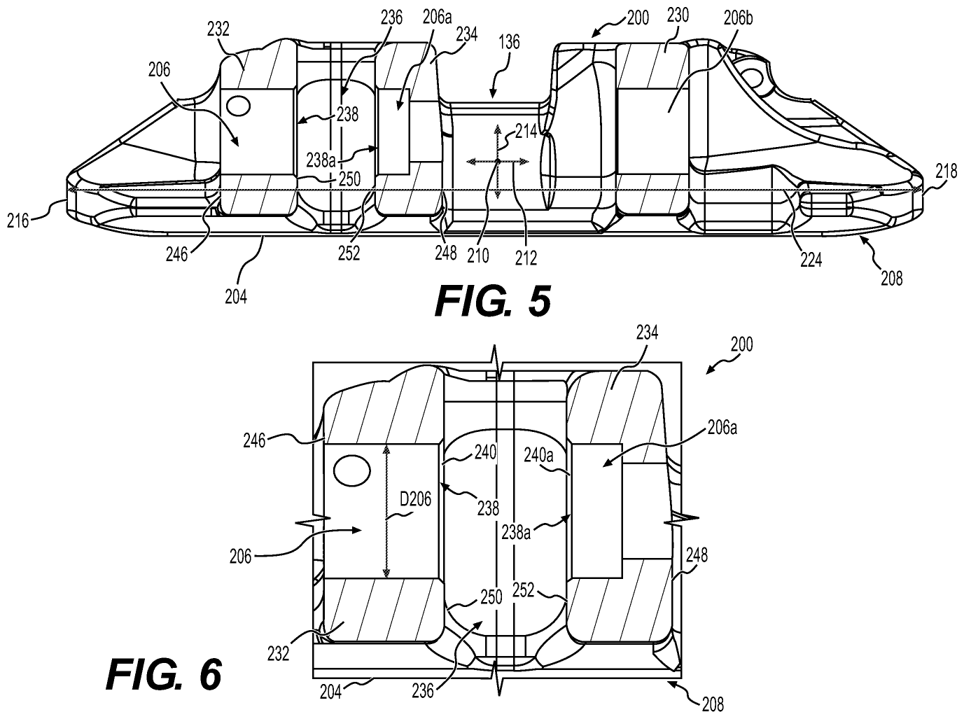

Such a track pad 200 may comprise a shoe member 208 including a ground engaging surface 204, and defining a track chain traveling direction 210, a lateral direction 212 that is perpendicular to the track chain traveling direction 210, and a vertical direction 214 that is perpendicular to both the lateral direction 212, and the track chain traveling direction 210. The shoe member 208 further defines a first lateral end 216, a second lateral end 218, a front end 220 along the track chain traveling direction 210, and a rear end 222 along the track chain traveling direction 210. A lateral distance 224 may be measured from the first lateral end 216 to the second lateral end 218 (see FIG. 5), as well as a width 226 from the front end 220 to the rear end 222 (see FIG. 2) along the track chain traveling direction 210 that is less than the lateral distance 224.

Looking at FIG. 2, a first link member 228 may extend upwardly from the shoe member 208 including a first lug member 230 extending from the first link member 228 in a first direction parallel to the track chain traveling direction 210, a second lug member 232, and a third lug member 234 both extending from the first link member 228 in a second direction opposite of the first direction, forming a first fork portion 244.

Referring now to FIGS. 3 thru 6, this fork portion may include a first lateral outside surface 246, a second lateral outside surface 248, a first lateral inside surface 250, and a second lateral inside surface 252. The second lug member 232 defines a first aperture (e.g., see 206) that extends laterally through the first lateral outside surface 246, and the first lateral inside surface 250, forming a first intersection with the first lateral inside surface 250 that includes a first blend 238 extending from the first lateral inside surface 250 to the first aperture.

The third lug member 234 may define a third aperture (e.g., see 206b) that extends from the second lateral inside surface 252 toward the second lateral outside surface 248, forming a second intersection with the second lateral inside surface 252 including a second blend (e.g., see 238a) extending from the second lateral inside surface 252 to the third aperture.

As alluded to earlier herein, the first blend, and the second blend may take the form of a plurality of chamfers (e.g., see 240, 240a). At least one of the plurality of chamfers may define an acute angle 256 with the lateral direction 212 that ranges from 30.0 degrees to 60.0 degrees (e.g., may be 45.0 degrees, see FIG. 4) in some embodiments of the present disclosure. This angular range may be different in other embodiments of the present disclosure.

Also, the first aperture defines a first diameter (e.g., see D206 in FIG. 6), and the first blend may define a first lateral chamfer distance 258. A ratio of the first diameter to the first lateral chamfer distance may range from 15.0 to 30.0 in some embodiments of the present disclosure. In such a case, the first lateral chamfer distance 258 may range from 3.0 mm to 7.0 mm (e.g., 5.0 mm). This may not be the case in other embodiments of the present disclosure.

Looking at FIG. 3, the third lug member 234 may define a first inside shoulder surface (e.g., see 242), and the third aperture (e.g., see 206a) may extend laterally to the first inside shoulder surface, while a first reduced diameter aperture 262 may extend laterally from the second lateral outside surface 248 to the third aperture. The reduced diameter aperture may be used to press out the cartridge pin assemblies when repair is desired.

A track pad 200 according to another embodiment of the present disclosure may also be described as follows looking at FIGS. 2 thru 6. A first link member 228 may extend upwardly from the shoe member 208 including a first top rail surface 202.

The second and the third lug members 232, 234 may define a first pair of chamfered surfaces (e.g., see 240, 240a) that are laterally opposite of each other and facing each other.

In addition, each of the first pair and the second pair of chamfered surfaces may form an acute angle 256 with the lateral direction 212 as mentioned earlier herein that ranges from 30.0 degrees to 60.0 degrees.

In such a case, at least one of the plurality of bores defines a first diameter (e.g., D206), and at least one of the first pair of chamfered surfaces defines a first radial chamfer distance 264. A ratio of the first diameter to the first radial chamfer distance may range from 15.0 to 30.0 (e.g., 18.0 to 22.0) in some embodiments of the present disclosure. When present, the first radial chamfer distance 264 may range from 3.0 mm to 7.0 mm (e.g., 5.0 mm).

The track pad may be a unitary body as shown or be an assembly of different parts. Often, the shoe member and the first rail member, and the second rail member consist essentially of metallic material such as cast iron, steel, grey cast iron, etc.

Any of the aforementioned features and their associated dimensions and/or ratios may be altered to be different than what has been shown or mentioned herein in other embodiments of the present disclosure.

### Industrial Applicability

In practice, a track chain assembly, a track pad or a portion thereof may be sold, manufactured, bought etc. and attached to the machine in the aftermarket or original equipment scenarios according to any of the embodiments discussed herein. That is to say, the machine may be sold with the track chain assembly, track pad and/or portion thereof according to embodiments described herein or the machine may be retrofitted, repaired, refurbished to use any of the embodiments discussed herein. The various components including, but not limited to the track pads, may be used from any suitable material such as cast iron, grey cast iron, steel, etc.

As can be seen, various embodiments of the track pad disclosed herein may provide reduce the likelihood of fouling of a seal assembly and/or a cartridge pin assembly by contaminants by providing a debris path for the egress of such contaminants away from the seal assembly. This may prolong the useful life of a track chain assembly using such track pads before maintenance is necessary, increasing the profit of an economic endeavor using the track pad(s).

As used herein, the articles “a” and “an” are intended to include one or more items, and may be used interchangeably with “one or more.” Where only one item is intended, the term “one” or similar language is used. Also, as used herein, the terms “has”, “have”, “having”, “with” or the like are intended to be open-ended terms. Further, the phrase “based on” is intended to mean “based, at least in part, on” unless explicitly stated otherwise.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, it is intended that the specification and examples be considered as exemplary only, with a true scope and spirit of the invention(s) being indicated by the following claims and their equivalents.

What is claimed is:

1. A track pad comprising:
a shoe member including a ground engaging surface, and defining a track chain traveling direction, a lateral direction perpendicular to the track chain traveling direction, and a vertical direction perpendicular to both the lateral direction, and the track chain traveling direction, the shoe member further defining a first lateral end, a second lateral end, a front end along the track chain traveling direction, and a rear end along the track chain traveling direction, a lateral distance from the first lateral end to the second lateral end, and a width from the front end to the rear end along the track chain traveling direction that is less than the lateral distance; and
a first link member extending upwardly from the shoe member including a first lug member extending from the first link member in a first direction parallel to the track chain traveling direction, a second lug member and a third lug member both extending from the first link member in a second direction opposite of the first direction, forming a first fork portion including a first lateral outside surface, a second lateral outside surface, a first lateral inside surface, and a second lateral inside surface;
wherein the second lug member defines a first aperture that extends laterally through the first lateral outside surface and the first lateral inside surface, forming a first intersection with the first lateral inside surface that includes a first blend extending from the first lateral inside surface to the first aperture.

2. The track pad of claim 1, wherein the third lug member defines a third aperture extending from the second lateral inside surface toward the second lateral outside surface, forming a second intersection with the second lateral inside surface including a second blend extending from the second lateral inside surface to the third aperture.

3. The track pad of claim 2, wherein the first blend, and the second blend are a plurality of chamfers.

4. The track pad of claim 3, wherein at least one of the plurality of chamfers define an angle with the lateral direction ranging from 30.0 degrees to 60.0 degrees.

5. The track pad of claim 4, wherein the angle is 45.0 degrees.

6. The track pad of claim 4, wherein the first aperture defines a first diameter, and the first blend defines a first lateral chamfer distance, and a ratio of the first diameter to the first lateral chamfer distance ranges from 15.0 to 30.0.

7. The track pad of claim 6, wherein the ratio ranges from 18.0 to 22.0.

8. The track pad of claim 6, wherein the first lateral chamfer distance ranges from 3.0 mm to 7.0 mm, the third lug member defines a first inside shoulder surface, the third aperture extends laterally to the first inside shoulder surface, and a first reduced diameter aperture extends laterally from the second lateral outside surface to the third aperture.

9. A track pad comprising:
a shoe member including a ground engaging surface, and defining a track chain traveling direction, a lateral direction perpendicular to the track chain traveling direction, and a vertical direction perpendicular to both the lateral direction, and the track chain traveling direction, the shoe member further defining a first lateral end, a second lateral end, a front end along the track chain traveling direction, and a rear end along the track chain traveling direction, a lateral distance from the first lateral end to the second lateral end, and a width from the front end to the rear end along the track chain traveling direction that is less than the lateral distance; and
a first link member extending upwardly from the shoe member including a first top rail surface;
a first lug member extending from the first link member in a first direction parallel to the track chain traveling direction, a second lug member and a third lug member both extending from the first link member in a second direction opposite of the first direction;
wherein the second and the third lug members define a first pair of chamfered surfaces that are laterally opposite of each other and facing each other.

10. The track pad of claim 9, wherein the second lug member, the third lug member, the fifth lug member, and the sixth lug member define a plurality of concentric bores, and at least one of the plurality of concentric bores are in communication with at least one of the second pair of chamfered surfaces.

11. The track pad of claim 10, wherein the each of the first pair and the second pair of chamfered surfaces form an angle with the lateral direction that ranges from 30.0 degrees to 60.0 degrees.

12. The track pad of claim 11, wherein at least one of the plurality of bores defines a first diameter, and at least one of the first pair of chamfered surfaces defines a first radial chamfer distance, and a ratio of the first diameter to the first radial chamfer distance ranges from 15.0 to 30.0.

13. The track pad of claim 12, wherein the first radial chamfer distance ranges from 3.0 mm to 7.0 mm.

14. A track chain assembly comprises:
a first track pad including a first pair of lugs defining a gap therebetween;
and
a second track pad including an intermediate lug disposed in the gap; wherein the first pair of lugs and the intermediate lug each defines a concentric bore, defining an axis of rotation for a pinned joint of the track chain assembly, and the concentric bore of one of the first pair of lugs is in communication with the gap with a first blend disposed axially between the gap and the concentric bore of one of the first pair of lugs.

15. The track chain assembly of claim 14, wherein the concentric bore of the other of the first pair of lugs is in communication with the gap with a second blend disposed axially between the gap and the concentric bore of the other of the first pair of lugs.

16. The track chain assembly of claim 15, wherein the first blend is a first interior chamfer and the second blend is a second interior chamfer.

17. The track chain assembly of claim 16, wherein each concentric bore defines the same diameter, and the track chain assembly further comprises a cartridge pin assembly that is disposed in each concentric bore, the cartridge pin assembly including a bushing defining a first bushing chamfer, and a second bushing chamfer that are in communication with the gap, and the first bushing chamfer forms a funnel angle with the first interior chamfer opening up toward the gap that is equal to 10 degrees or greater.

18. The track chain assembly of claim 17, wherein the first bushing chamfer is spaced away from the first interior chamfer a minimum distance, forming a first debris path, and the bushing defines an outer bushing diameter.

19. The track chain assembly of claim 18, wherein the cartridge pin assembly defines a seal receiving void that is in communication with one of the concentric bores, and the first debris path, and a ratio of the bushing diameter to the minimum distance ranges from 15.0 to 30.0.

20. The track chain assembly of claim 19, wherein the minimum distance ranges from 3.0 mm to 7.0 mm, and one of the first pair of lugs includes a shoulder stop surface and the cartridge pin assembly is disposed axially adjacent to the shoulder stop surface.
